(19) United States
(12) Patent Application Publication
(10) Pub. No.: US 2026/0061440 A1
(43) Pub. Date: Mar. 5, 2026

(54) SPRAY GUN WITH TOP MOUNTED CONTROL

(71) Applicant: FUJI INDUSTRIAL SPRAY EQUIPMENT LTD., TORONTO (CA)

(72) Inventors: Kuei-Hsiang SHIH, Taichung City (TW); Mark ROSIN, THORNHILL (CA); David Michael SHERMAN, TORONTO (CA); Paul Michael SMITH, TORONTO (CA); Jonathan Paul LOUDON, TORONTO (CA); Jason MACDONALD, TORONTO (CA)

(21) Appl. No.: 18/819,686

(22) Filed: Aug. 29, 2024

(30) Foreign Application Priority Data
Aug. 29, 2023 (CN) 112209214
Aug. 29, 2023 (CN) 112304385
Oct. 24, 2023 (TW) 2023228549086

(51) Int. Cl. B05B 7/24; B05B 12/00; B05B 12/18

(52) U.S. Cl. CPC B05B 7/2429; B05B 12/002; B05B 12/18

(57) ABSTRACT

A spray gun for use in association with a fluid container includes a gun body, a gun head, a main airflow channel and a top knob controller. The gun body has a control seat formed therein on a top portion of the gun body. The gun head is operably attached to the front of the gun body. The main airflow channel is in the gun body and divided into a fist flow opening and a second flow opening at a base of the control seat. It is operably connected to the gun head. The top knob controller is operably connected to the control seat whereby adjusting it controls the air flow into the first flow opening and the second flow opening thereby controlling the spray pattern. A needle body assembly includes a needle body; a needle handle; and a needle sleeve operably connecting the needle body to the needle handle.

### BACKGROUND

The present disclosure relates generally to spray guns and to spray guns with a top mounted control.

There are a wide variety of spray guns known in the art and are used in a wide variety of industries. These spray guns have a number of different control mechanisms. Some rely on side control knobs and others rely on back control knobs. The spray guns with side control knobs are typically built for right-handed users and therefore it is difficult for left-handed users. The spray guns with rear knob controls are awkward to use because typically all of the knobs are positioned close to each other.

Whilst these spray guns may work well in controlled situations, for use of a spray gun in a retail environment the existing spray guns can be difficult to use. For example, in such places like tanning salons the existing spray guns can be difficult to use.

Accordingly, it would be advantages to provide a spray gun that is easy to use for either a right-handed or left-handed user.

### SUMMARY

A further understanding of the functional and advantageous aspects of the disclosure can be realized by reference to the following detailed description and drawings.

A spray gun for use in association with a fluid container includes a gun body, a gun head, a main airflow channel and a top knob controller. The gun body has a control seat formed therein on a top portion of the gun body. The gun head is operably attached to the front of the gun body. The main airflow channel is in the gun body. The main airflow channel is divided into a fist flow opening and a second flow opening at a base of the control seat. The main airflow channel is operably connected to the gun head. The top knob controller is operably connected to the control seat whereby adjusting the top knob controller controls the air flow into the first flow opening and the second flow opening thereby controlling the spray pattern.

The top knob controller may include a valve. The valve may include a wedge-shaped stopper protruding and extending therefrom. The wedge-shaped stopper may have a protruding point adapted to be positioned in registration with an arc-shaped guide groove formed at a bottom of the control seat of the gun body. The arc-shaped guide groove may limit the movement of the wedge-shaped stopper.

The spray gun may include a needle assembly in the main airflow channel. The needle assembly may include a needle body, a needle handle and a needle sleeve operably connecting the needle body to the needle handle. The needle body may have a groove on the proximal end thereof and the needle assembly may further include a C-shaped fastener configured to sit in the groove. The needle sleeve may be pushed onto the needle body. The needle sleeve may have threads on an outer surface thereof, the needle handle may have a connected portion with a threaded seat and the needle sleeve and the needle handle may be screwed together.

A needle body assembly for use in a spray gun includes a needle body; a needle handle; and a needle sleeve operably connecting the needle body to the needle handle.

### BRIEF DESCRIPTION OF THE DRAWINGS

Embodiments will now be described, by way of example only, with reference to the drawings, in which:

FIG. 1 is a perspective view of a prior art spray gun having a side mounted control;

FIG. 2 is a perspective view of an alternate prior art spray gun having a back mounted control;

FIG. 3 is a perspective view of a spray gun having a top mounted control of an embodiment of the present disclosure;

FIG. 4 is a perspective view of the spray gun of FIG. 3 showing the top control blown apart;

FIG. 5 is a side view of the spray gun of FIG. 3 showing the top portion as a sectional view;

FIG. 6 is a cross-sectional view of the top control of the spray gun of FIG. 3 shown in an open position;

FIG. 7 is a cross-sectional view similar to that of FIG. 6 showing the top control of the spray gun of FIG. 3 but showing the control in a closed position;

FIG. 8 is perspective view of the needle assembly of the spray gun of FIG. 3 as viewed from the right side and showing the spray gun in phantom;

FIG. 9 is a blown apart perspective view of the needle assembly shown in FIG. 8; and

FIG. 10 is a sectional view of the needle assembly shown in FIG. 8.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein the “operably connected” or “operably attached” means that the two elements are connected or attached either directly or indirectly. Accordingly, the items need not be directly connected or attached but may have other items connected or attached therebetween.

It is to be noted that the specification and claims of the application and the terms “first”, “second” and the like in the drawings are used to distinguish similar objects, and do not need to describe a specific sequence or a precedence order. It will be appreciated that data used in such a way may be exchanged under appropriate conditions, in order that the embodiments of the application described here can be implemented in a sequence other than sequences graphically shown or described here. In addition, terms “include” and “have” and any variations thereof are intended to cover non-exclusive inclusions. For example, it is not limited for processes, methods, systems, products or devices containing a series of steps or modules or units to clearly list those steps or modules or units, and other steps or modules or units which are not clearly listed or are inherent to these processes, methods, products or devices may be included instead.

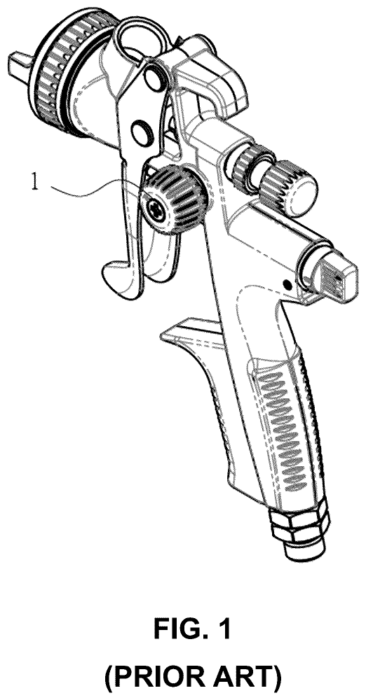

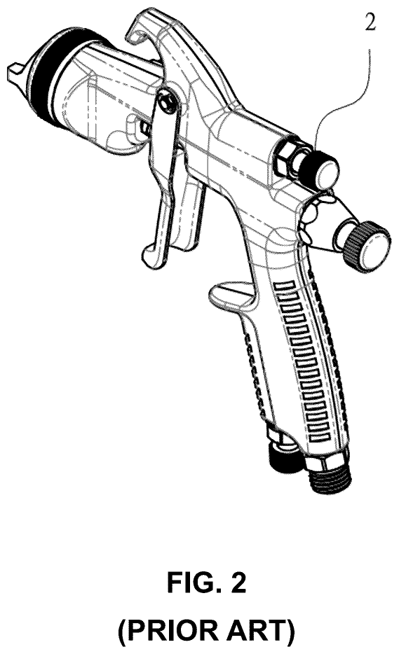

Typical prior art spray guns either have a control knob on the side as shown in FIG. 1 at 1 or rear control knob as shown in FIG. 2 at 2. Each of these configurations pose challenges to the user. The side control knob is typically configured for a person who is right-handed. Therefore, it is typically difficult or challenging for a left-handed user. The spray guns with a rear control knob can also be challenging to use because the handle and control knob are very close to each other and thus the user needs to have both hands very close together to control the gun making it somewhat awkward to use.

The following examples are presented to enable those skilled in the art to understand and to practice embodiments of the present disclosure. They should not be considered as a limitation on the scope of the disclosure, but merely as being illustrative and representative thereof.

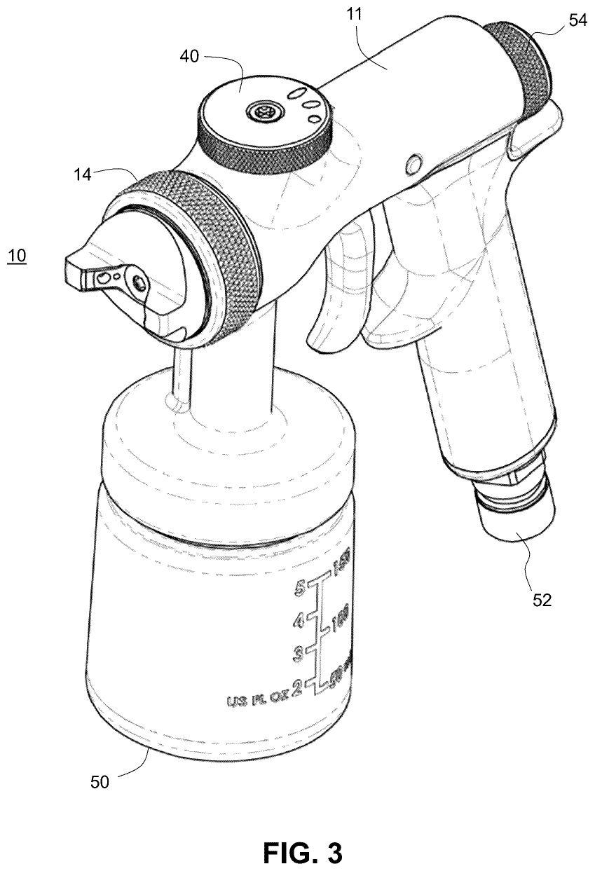

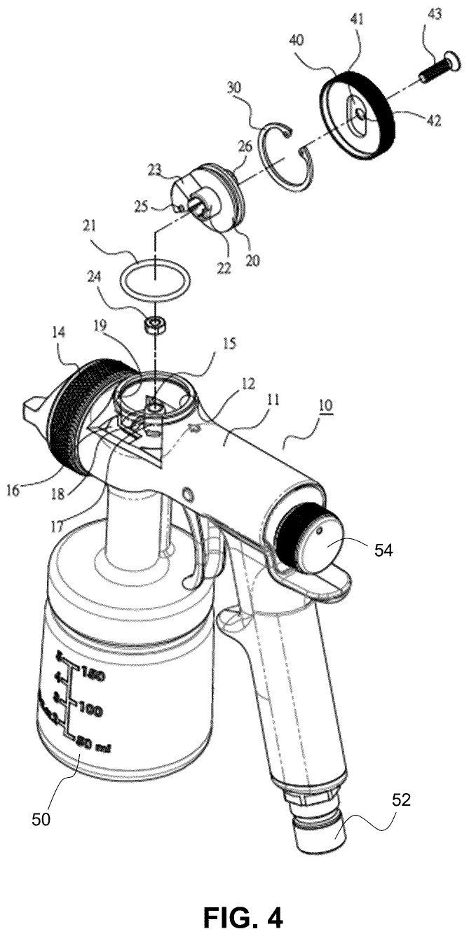

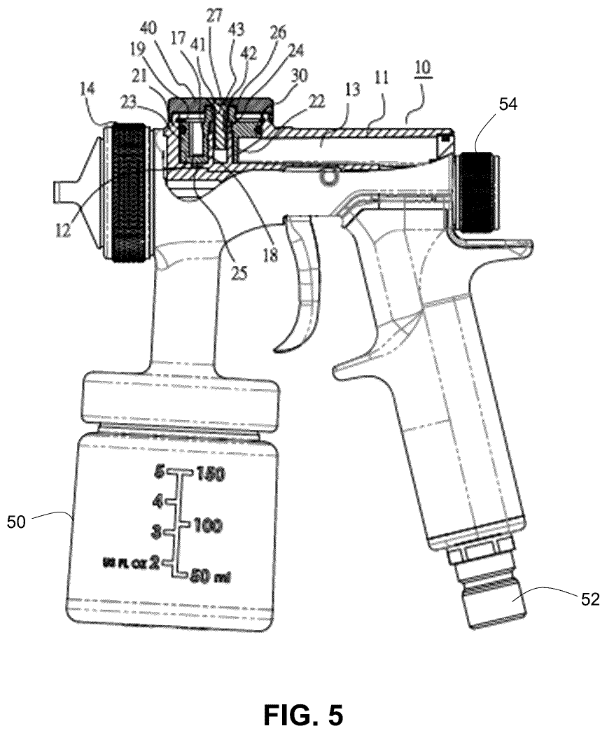

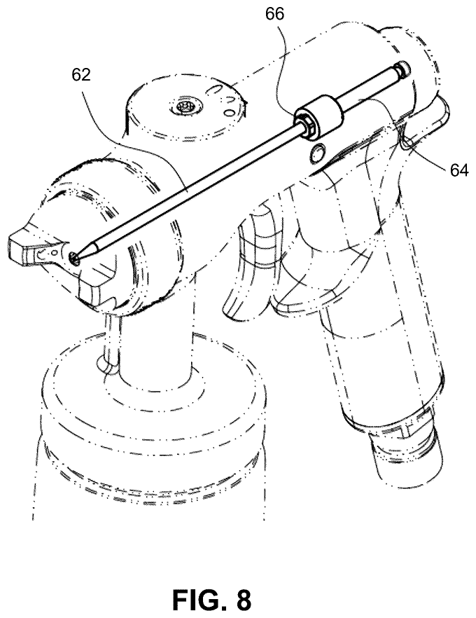

Referring to FIGS. 3 to 7, a spray paint gun with a top controller is shown generally at 10. Spray gun 10 includes a gun body 11, a gun head 14, a top knob controller 40 and is operably connectable to a liquid container 50. The spray gun 10 has an inlet port 52 and a fluid adjustment knob 54. Needle assembly 60 (shown in FIG. 8) is operably connected to fluid adjustment knob 54. Spray gun 10 may be used with air supplied by a high-volume, low pressure (HVLP) turbine blower. The inlet port 52 is at the bottom of the handle tube of the spray gun 10 and is for receiving compressed air from an HVLP blower such as a turbine blower (not shown).

The gun body 11 has a main airflow channel 13 formed therein. The gun body 11 is provided with a control seat 12 formed therein on a top portion of the gun body. The control seat 12 is operably connected to the main airflow channel 13 of the gun body 11 and is in flow communication therewith. The top knob controller assembly is operably connected to the control seat 12. The positioning of the control seat 12 on the top of the gun body provided easy access to the controller 40 for either a left-handed user or a right-handed user.

The main airflow channel 13 is in flow communication with the gun head 14 and is connected to the gun head 14. The gun head 14 is at the front of the gun body 11. The main airflow channel 13 is divided into two flow openings, a first flow opening 15 and a second flow opening 16 at the base of the control seat 12. Knob 40 is operably connected to the control seat 12 to control the air flow. It is operated to cut-off airflow to one of the first flow opening 15 or the second flow opening 16 and then to open the airflow on the other of the first or second flow opening. This changes the fan pattern from a small round shape to a large oval shape. Therefore, adjusting the top knob controller 40 controls the air flow into the first flow opening 15 and the second flow opening 16 thereby controlling the spray pattern.

Top knob controller assembly includes a knob 40 and a valve 20 operably connected on the inside thereof. Valve 20 has an anti-leak ring 21 on its outer periphery. Valve 20 is pivotally connected to the seat 12 at the top of the body 11 of the spray gun 10. Valve 20 has a bucket seat 22 and a wedge-shaped stopper 23 protruding and extending therefrom provided on one end surface of the bucket seat 22. A nut 24 is placed at the inner bottom of the bucket seat 22. The bucket seat 22 is set on the hollow cylinder 17 at the bottom of the control seat 12 of the gun body 11. The end face of the wedge-shaped stopper 23 has a positioning protruding point 25 extending therefrom. Nut 43 of the top knob controller assembly holds the knob 40 and valve in position in the seat 12. The protruding point 25 is positioned in registration with the arc-shaped guide groove 18 at the bottom of the control seat 12 of the gun body 11. The arc-shaped groove 18 limits the movement of the valve 20 in the knob assembly. On the other side of valve 20 a connecting portion 26 protrudes therefrom and a hole 27 is formed therein recessed at the end face pivot and penetrates the valve 20. A fastener 30 is C-shaped and is fastened to a groove 19 formed on the inner edge of the control seat 12 of the gun body 11 proximate to the open end thereof.

Knob 40 has a dish-shaped body, with a connecting seat 41 recessed at the bottom of the dish. Connecting seat 41 is shaped to receive the connecting portion 26 of the valve 20. The bottom of the connecting seat 41 is provided with a hole 42, and a screw 43 is positioned in the hole 42 to be fastened to the valve 20 in the bucket seat 22 and nut 24.

The control seat 12 includes a hollow cylinder 17 which is convexly provided at the pivot, and an arc-shaped guide groove 18 is concavely provided on the side of the hollow cylinder 17.

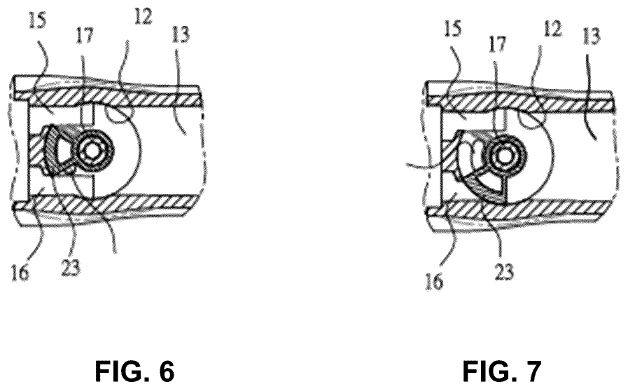

Referring to FIGS. 6 and 7, when the valve 20 does not block the second flow passage opening 16, the airflow of the main airflow channel 13 of the gun body 11 can flow smoothly through the first flow channel opening 15 and the second flow channel opening 16 without obstruction and enter the gun head 14. Alternatively, when the valve 20 is rotated, the second flow channel opening 16 can be fully closed or half-opened to fine-tune the spray pattern. The wedge-shaped stopper 23 of the valve 20 is used to control the flow of air in the first flow channel opening 15 and the second flow channel opening 16 as best seen in FIGS. 6 and 7. The knob 40 is placed on the top of the gun body 11 so that it can be operated by both left and right hands.

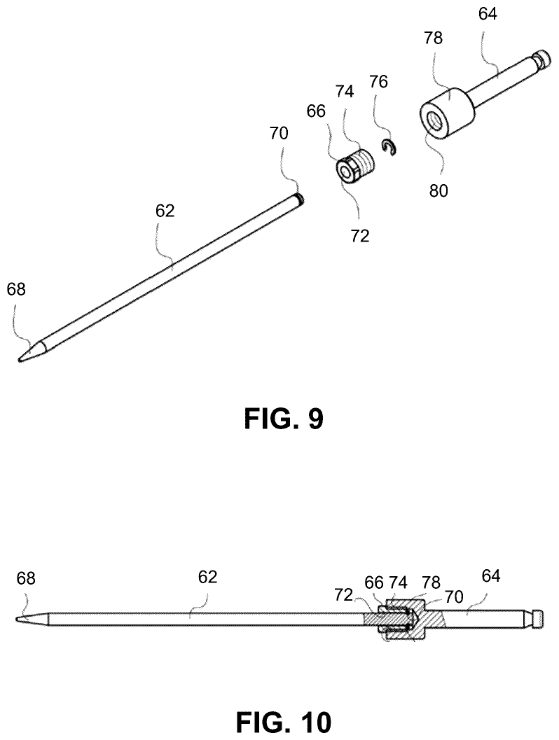

Referring to FIGS. 8 to 10, spray gun 10 incudes a needle assembly 60 in the airflow channel 13. Needle assembly 60 includes a needle body 62 operably connected to a needle handle 64. A needle sleeve 66 operably connects the needle body 62 to the needle handle 64.

The needle body 62 is in the shape of a thin rod, the distal end or one end thereof is generally needle-shaped 68, and the proximal end or the other end has a positioning groove 70. The needle sleeve 66 is tube shaped with a hole 72 therein at its end pivot, and the outer exterior surface is provided with threads 74. The needle sleeve is operably connected to the needle body 62. A C shaped fastener 76 sits in the positioning groove 70 of the needle body 62 and the sleeve 66 is pushed thereon. The diameter of the hole 72 is slightly larger than the rod-shaped diameter of the needle body 62.

The needle handle 64 has a connecting portion 78 with a larger outer diameter than the handle body 62 at one end. The top of the connecting portion 78 is recessed.

The connecting portion 78 is a threaded seat 80, and a needle sleeve 66 is screwed together. The needle body 62 is combined with the needle handle 64 by the needle sleeve 66. There is a slight gap between the end fastened by the fastener 76 and the bottom of the threaded seat 80 of the connecting portion 78 of the needle handle 66. With the above components, the needle body 62 is different from the needle sleeve 66 in diameter, and is different from the needle handle 64.

The gap left at the bottom of the seat threaded 80 of the connecting portion 78 makes the needle body 62 moveable.
The needle assembly 60 is concentrically positioned in the gun body 11 of spray gun 10. The problem and the constraint conditions of the anti-leak structure can be accommodated and absorbed by the movement margin of the needle body 62 and needle handle 64. The needle assembly 60 shown herein allows for some flexibility and movement when installed in a spray gun. This is in contrast to conventional needles which are one or two pieces and are typically more rigid than the needle assembly shown herein.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A spray gun for use in association with a fluid container comprising:
a gun body having a control seat formed therein on a top portion of the gun body;
a gun head operably attached to the front of the gun body;
a main airflow channel in the gun body, the main airflow channel being divided into a fist flow opening and a second flow opening at a base of the control seat, wherein the main airflow channel is operably connected to the gun head; and
a top knob controller operably connected to the control seat whereby adjusting the top knob controller controls the air flow into the first flow opening and the second flow opening thereby controlling a spray pattern.

2. The spray gun as claimed in claim 1 wherein the top knob controller includes a valve.

3. The spray gun as claimed in claim 2 wherein the valve includes a wedge-shaped stopper protruding and extending therefrom.

4. The spray gun as claimed in claim 3 wherein the wedge-shaped stopper has a protruding point adapted to be positioned in registration with an arc-shaped guide groove formed at a bottom of the control seat of the gun body.

5. The spray gun as claimed in claim 4 wherein the arc-shaped guide groove limits the movement of the wedge-shaped stopper.

6. The spray gun as claimed in claim 1 further including a needle assembly in the main airflow channel.

7. The spray gun as claimed in claim 6 wherein the needle assembly includes a needle body, a needle handle and a needle sleeve operably connecting the needle body to the needle handle.

8. The spray gun as claimed in claim 7 wherein the needle body has a groove on the proximal end thereof and further including a C-shaped fastener configured to sit in the groove and the needle sleeve is pushed onto the needle body.

9. The spray gun as claimed in claim 8 wherein the needle sleeve has threads on an outer surface thereof, the needle handle has a connected portion with a threaded seat and the needle sleeve and the needle handle are screwed together.

10. A needle body assembly for use in a spray gun comprising:
a needle body;
a needle handle; and
a needle sleeve operably connecting the needle body to the needle handle.

11. The needle body assembly as claimed in claim 10 wherein the needle body has groove on the proximal end thereof and further including a C-shaped fastener configured to sit in the groove and the needle sleeve is pushed onto the needle body.

12. The needle body assembly as claimed 8 wherein the sleeve has threads on an outer surface thereof, the needle handle has a connected portion with a threaded seat and the needle sleeve and the needle handle are screwed together.
